(19) United States
(12) Patent Application Publication
(10) Pub. No.: US 2010/0163713 A1
(43) Pub. Date: Jul. 1, 2010

(54) ELECTROMAGNETIC WAVE SENSING APPARATUS

(75) Inventors: CHIA-CHU CHENG, TAIPEI COUNTY (TW); PO-CHENG CHANG, TAIPEI COUNTY (TW); MENG-KUN CHEN, KAOHSIUNG COUNTY (TW); CHIA-CHENG LEI, TAIPEI COUNTY (TW); HSING-YEN WU, TAINAN CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORP., TAIPEI HSIEN (TW)

(21) Appl. No.: 12/683,682

(22) Filed: Jan. 7, 2010

Related U.S. Application Data
(63) Continuation-in-part of application No. 12/073,719, filed on Mar. 10, 2008, now abandoned.

(51) Int. Cl. G01J 1/42

(52) U.S. Cl. 250/214 AL; 250/214 C

(57) ABSTRACT

An electromagnetic wave sensing device and an operating method for the same are disclosed. The claimed device integrates signal transformation, operation and a sensing range configuration. Particularly, the sensing apparatus at least has two sensing units that respectively sense the ambient light and the electromagnetic wave with a specific range of spectrum. Moreover, a temperature sensor is further introduced to compensate the sensed signals by eliminating the temperature influence. Since the output of the sensing device can have a stable characteristic, the downstream manufacturers don't need to use different hardware or software to adapt different product conditions. The preferred embodiment is to provide one electromagnetic wave sensing device having at least two sensing units for respectively sensing different ranges of electromagnetic waves. After signal transformation, the signals are outputted according to the working mode configured by a control unit.

### CROSS-REFERENCE TO RELATED APPLICATIONS

This Application is a Continuation-in-Part of application Ser. No. 12/073719, filed on 10 Mar. 2008, and entitled ELECTROMAGNETIC WAVE SENSING APPARATUS.

### BACKGROUND OF THE INVENTION

1. Field of the Invention

The present invention relates to an electromagnetic wave sensing device; in particular, to an electromagnetic wave sensing device with at least two sensing units respectively used to sense ambient light and electromagnetic wave of specific wavelength range.

2. Description of Related Art

The electromagnetic sensing devices in prior art, such as photo sensing device, employ photo-electric effect, in which the sensing unit, e.g. photo diode, may convert the received light energy into electrical signals, also known as photo-electric current.

The photo sensing device can be widely applied to ambient light sensing. The sensing circuit for ambient light is commonly used in the back-light panel in Liquid Crystal Displayers (LCD) screen, whose main purpose is that, as looking at the contents displayed on the screen, the brightness of ambient light may affect the displayed effect; through the feature of ambient light sensing provided by such a sensing circuit, it is possible to cause the back-light module in the screen of the displayer to generate a display effect that the brightness changes but comparatively the brightness of the back-light is not affected. For example, at the outdoor with brighter ambient light, the display screen on a mobile phone can generate back-light with higher brightness, allowing a user to be able to clearly see the contents shown thereon; contrarily, when being indoor with dimmer ambient light, back-light may generate lower brightness so as to save energy.

Related technology, such as the US patent application with publication number 2005/0219228 issued on Oct. 6, 2005, describes a sensing device installed in a mobile device, therein a plurality of sensors are disclosed, as shown in FIG. 1, in which the sensing device 10 includes a plurality of sensors, such as photo sensor 11 and proximity sensor 12. The photo sensor 11 is used to detect the intensity of ambient light, and the proximity sensor 12 is used to detect approaching object and motion thereof. In this application, the sensing device 10 needs to use an integrated circuit 13 to integrate the signals and features of each sensing unit, and provides a user interface (not shown), enabling other hosts to set different sensing functions. However, each of different sensors has respectively its different interface and control environment.

Furthermore, the US patent application with publication number 2007/0085157 issued on Apr. 19, 2007 describes an integrated sensor, as shown in FIG. 2, which includes an integrated sensing device 20 directed to ambient light and moving objects sensing. The sensing device has both an emitter 21 and a detector 22 for electromagnetic detection.

The sensing device 20 provides a feature of ambient light sensing, which is further coupled to a microcontroller 23 in a host. The microcontroller 23 is used to switch the modes of the sensing device 20, including a mode of approaching object sensing and a mode of ambient light sensing, and the microcontroller 23 transfers in turn the sensed signal to a microprocessor 24, and the microprocessor 24 may be further coupled with other components 25 and provide suitable data thereto. In particular, when the sensing device 20 is executing the function of approaching object sensing, the detector 22 detects the electromagnetic wave emitted by the emitter 21; while the emitter 21 may be temporarily turned off in advance, letting the detector detect other signals in addition to the electromagnetic wave generated by the emitter 21.

The detection workflow created by the aforementioned technologies may be shown in FIG. 3, which essentially expresses the operational method of two sensors within one sensing device, so as to sense a moving object and other light sources. Step S301 shows that electromagnetic wave of known waveband is emitted from an emitter in this sensing device; next, in step S303, under the mode of approaching object sensing, the detector detects the electromagnetic generated by the emitter; then, in step S305, it shows that it may sense other light sources under the mode of ambient light sensing.

Some prior arts use one or more sensors in one device to monitor various forms of electromagnetic waves. According to one more prior art such as U.S. Pat. No. 7,135,976 (issued on Nov. 14, 2006), a wireless monitor device has been provided to includes more than one sensors detect the various forms of energies including visible light, infrared light, magnetic fields, radio frequency energy and sound. U.S. Pat. No. 7,135,976 also discloses the monitor having a sleep mode for conserving power, a continuous mode for continuously monitoring, and a mode for periodically waking-up a microprocessor to take readings and perform other tasks.

### SUMMARY OF THE INVENTION

Distinguished from a sensing device having a sensor of different sensing functions provided by prior art, the objective of the present invention is to provide an electromagnetic sensing device with two different electromagnetic sensing ranges, which sets the sensing range of the sensing unit therein through switching of operating mode.

The preferred embodiment of the said electromagnetic wave sensing device includes a first sensing unit, which has one or more sensing components therein, such as photo-diode, used to sense ambient light and generate a first sensing signal; further includes a second sensing unit, which has one or more sensing components therein, so as to sense electromagnetic wave of a specific range and generate a second sensing signal. Afterwards, it receives the sensing signals from the first sensing unit and the second sensing unit by means of sensing signal processing to perform data process, including signal transformation, operating mode setting of the electromagnetic sensing device etc.

The above-mentioned first sensing unit and second sensing unit respectively senses different light sources, which may be set according to various needs, including ambient light sensing and electromagnetic wave sensing of individual bands. The electromagnetic sensing device further provides a signal transforming unit, which can transform light signal into electrical signal, including linear-to-linear and linear-to-log electrical signals. Such a sensing signal process may set the sensing signal wavebands that the sensing device is required to receive, and also control the stop or start of operation in the first sensing unit or the second sensing unit, as well as operating time thereof, through parameters,

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a diagram of a sensing device having a plurality of sensors in prior art;

FIG. 2 illustrates a diagram of an integrated sensing device in prior art;

FIG. 3 illustrates a detection flowchart in prior art;

FIG. 4 illustrates a diagram of a preferred embodiment of the electromagnetic wave sensing device according to the present invention;

FIG. 5 depicts a frequency response chart of electromagnetic wave discernible by human eyes; and

FIG. 6 illustrates a circuit block diagram of a preferred embodiment of the electromagnetic wave sensing device according to the present invention;

FIG. 7 draws one more embodiment of a circuit block diagram of the preferred embodiment of the sensing device in accordance with the present invention.

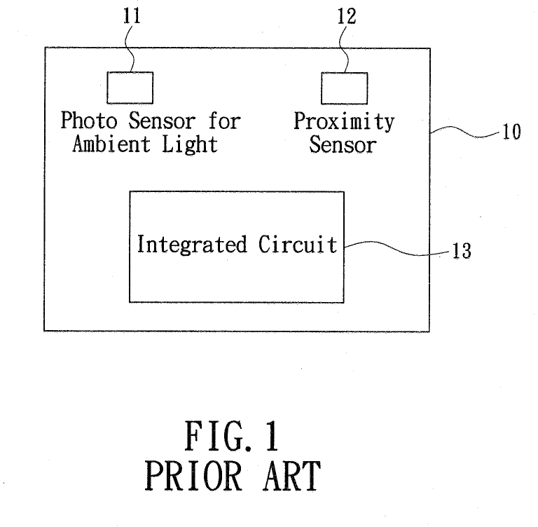

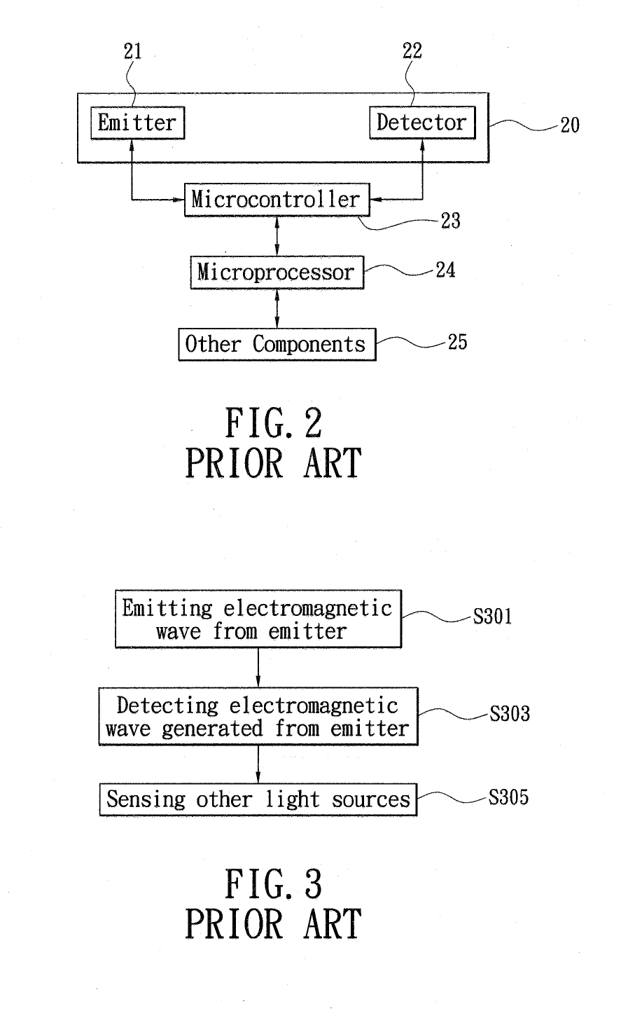

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The electromagnetic wave sensing device provided by the present invention can integrate the sensing units for sensing electromagnetic wave energy from environment or specific electromagnetic wave sources, and includes a circuit of post-sensing signal process, such as the analog-to-digital signal transforming circuit for transforming light signal into electrical signal, comprising setting the electromagnetic sensing ranges and parameters transferred therein, and even performing signal interrupt process between other processing units therewith. Through various setting, it is possible to enable the final output to have a specific feature, such that the companies using such a product do not need to employ different hardware or software algorithm according to different product supplied.

The electromagnetic wave sensing device provided by the present invention is essentially to install a plurality of sensing units within a sensing device, which includes at least two types of electromagnetic wave sensing devices for sensing different electromagnetic wave ranges, enabling to set the sensing ranges in the sensing units based on actual need. In a preferred embodiment, it may respectively sense ambient light and electromagnetic wave of specific wavelength range.

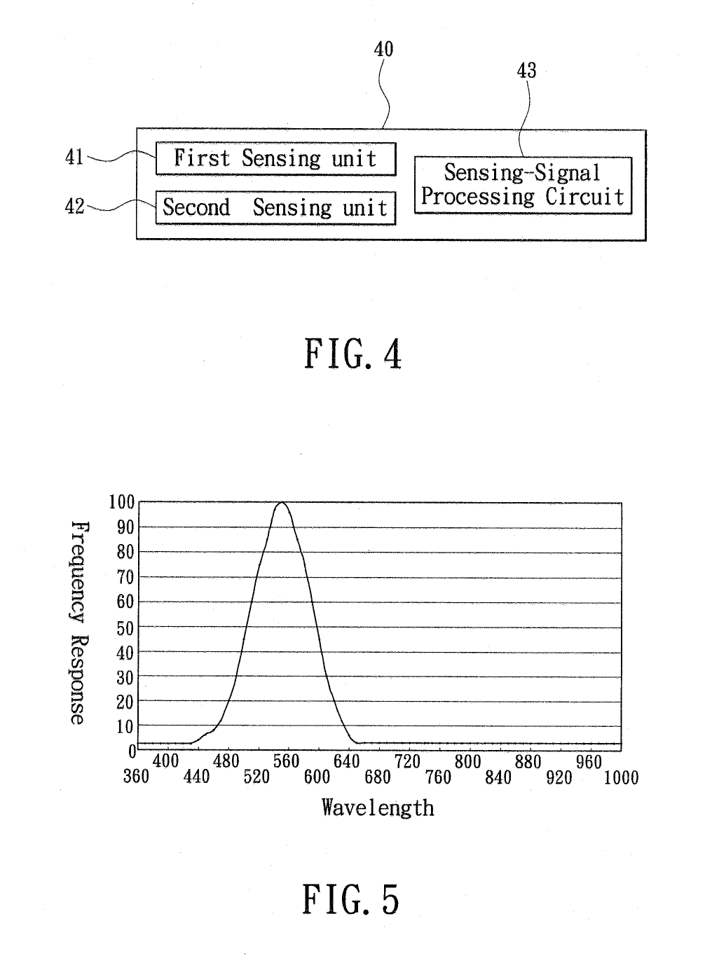

Referring to FIG. 4, a diagram of a preferred embodiment of the electromagnetic wave sensing device according to the present invention is shown, which illustrates a sensing device 40 having multiple sensing units, at least including a first sensing unit 41 and a second sensing unit 42 as depicted therein; particularly, these two sensing units may individually sense different ranges of electromagnetic wave, and both include at least a sensing component (not shown), such as photodiode, so as to respectively sense ambient light and electromagnetic wave of specific range, and generate corresponding sensing signal, including a first sensing signal and a second sensing signal.

The electromagnetic wave of specific ranges sensed by the aforementioned first of second sensing unit may include visible and invisible light, and the included sensing components may be a plurality of diode components, e.g. photodiode, whose embodiment may be a diode component having a substrate with PN interfacing, metal layer, polymer layer or combination thereof stacked thereon. The sensing component in each sensing unit can alter its sensing waveband by modifying the process parameters, so as to decide the feature of the component and sensible range of electromagnetic wave during manufacture process.

The sensing device 40 further includes a means of sensing signal post-process, which may be a sensing-signal processing circuit 43, used to receive the sensing signal generated by the sensing component in each of the above-mentioned sensing unit, It may perform photo-electric signal transformation via a signal transforming unit for transforming light signal into electrical signal, and because that the light signal generated by receiving external electromagnetic wave is usually analogous, it will be hence converted again to digital electrical signal, including voltage or current signal, and the obtained result will be further output based on the working mode of the electromagnetic wave sensing device.

Besides, the means of sensing signal process can deal with electromagnetic wave with a specific wavelength from an external electromagnetic radiation source, and control the stop/start operation of the first sensing unit 41 or second sensing unit 42, as well as the operating time for each sensing unit, through parameters. It can especially set the specific sensing range of electromagnetic wave within the detecting range of each sensing unit, including visible light, invisible light, or limited to ambient light that human eye can distinguish.

The above-mentioned working mode may include full working mode, that is, it may perform light sensing any time, and sends interrupt request after the interrupt condition(s) is/are matched; and sleep mode, which means the sensing device enters into an operation-halted condition. Additionally, the electromagnetic wave sensing device 40 provided by the present invention can further include a semi-sleep mode, which initiates periodically the said electromagnetic wave sensing device for sensing electromagnetic energy generated by the electromagnetic wave source in a periodic way, instead of performing sensing function constantly, so as to reduce power consumption without stopping the work thereof.

Subsequently, the first sensing unit 41 and second sensing unit 42 in the above-mentioned electromagnetic wave sensing device 40 may further include an electromagnetic wave filter (not shown), which can filter an electromagnetic wave range to an electromagnetic wave range discernible by human eyes, such as, within the electromagnetic waveband of ranging from 450 nm to 650 nm, the maximum peak therein is about 550 nm. Referring to FIG. 5, wherein a frequency response chart of electromagnetic wave discernible by human eyes is shown.

Besides, the electromagnetic wave sensing device 40 further includes a means of coupling, allowing to be coupled to other application devices, including electrically connected with a host through a transmission interface. One preferred embodiment is I2C serial transmission interface, thus the sensing signal therein can be transformed into a signal consistent with I2C serial transmission interface standard, and in turn electrically connected to the host via I2C serial transmission lines. Practical application may further include USB interface, IEEE1394 interface, RS-232, or other interfaces consistent with the specifications of various industrial standards.

In one embodiment, the electromagnetic wave sensing device disclosed by the present invention further provides an ability of setting more than two interrupt points, and through the above-stated sensing-signal processing circuit which executes one or more interrupt conditions, with each interrupt point disperses in different energy range, when the energy of the electromagnetic wave matches one of the interrupt conditions, it can send an sensing signal to the host. Each interrupt point corresponds to different electromagnetic wave energy and signal intensity, indicating the electromagnetic wave sensing device according to the present invention can generate multiple types of sensing signals, meet different needs and provide feature of customization.

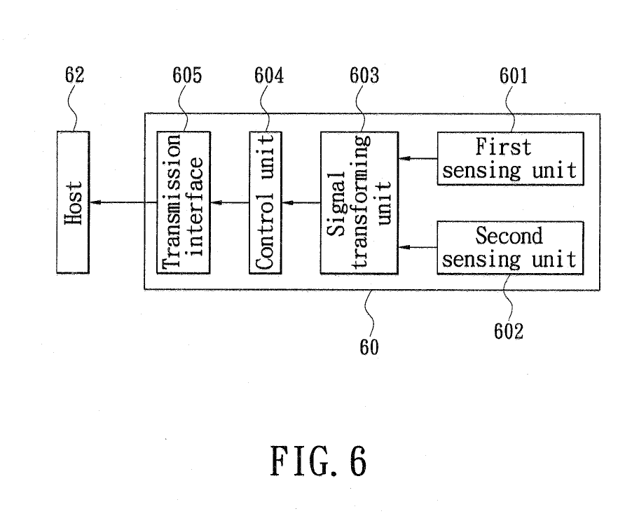

Another embodiment of the electromagnetic wave sensing device according to the present invention combines a plurality of electromagnetic wave sensing units, forming thus an electromagnetic wave sensing device capable of sensing a plurality of electromagnetic wave sources, as shown in the embodiment diagram of FIG. 6.

The electromagnetic wave sensing device 60 similarly integrates a transmission interface 605, a control unit 604 and a signal transforming unit 603, and further consists of two or more sensing units 601, 602, hence the electromagnetic wave sensing device 60 can sense electromagnetic waves in more than two wavebands, with sensing components (not shown) in each sensing units 601, 602 also have features of sensing different electromagnetic wavebands, which can be determined during manufacture process. These two electromagnetic wave sensing units 601, 602 are electrically connected to the signal transforming unit 603, and collectively uses the signal transforming unit 603, control unit 604 and transmission interface 605, and can switch manually the electromagnetic wave sensing unit needed to be employed, or initiate different electromagnetic wave sensing unit according to different electromagnetic wave, or else start both simultaneously to create broader sensing range. The scope of the present invention is limited to the present embodiment.

For example, the first sensing unit 601 can be a sensing unit for sensing ambient light, whose principal sensing range lies in the visible band, while the second sensing unit 602 is for sensing invisible light, whose sensing rang is within the invisible light band, such as ultraviolet ray, infrared ray and so forth. When the plurality of electromagnetic wave sensing units such as the first sensing unit 601 or second sensing unit 602 receive some electromagnetic wave sources in a specific band range, a plurality of analogous signals will be generated and converted by the signal transforming unit 603 into a plurality of digital signals. Then the control unit 604 calculates the output range so as to determine whether a certain interrupt condition is met, or control the sensing mode thereof (full working mode, sleep mode or semi-sleep mode), sending interrupt request to the host 62, and, after reception of response, it transfers sensing signal to the host 62.

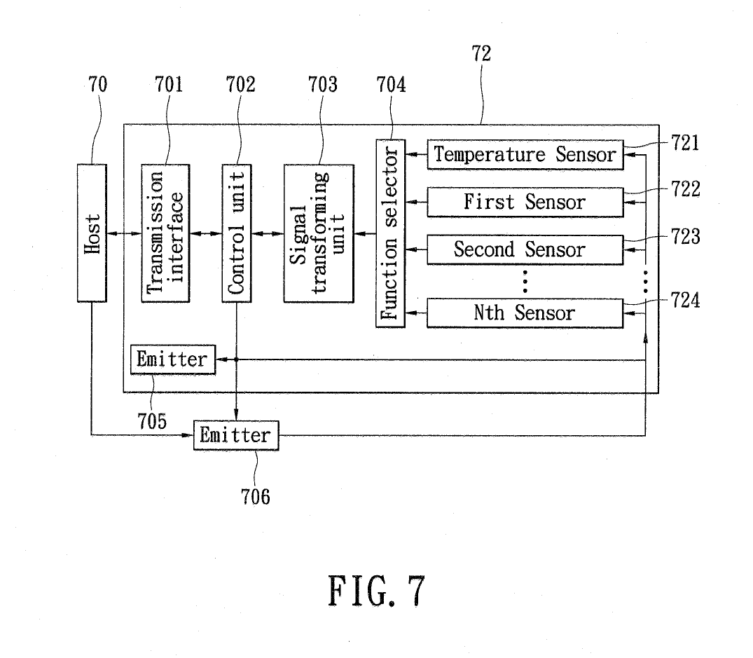

According to one more embodiment of the present invention FIG. 7, a circuit block diagram of the sensing device is disclosed. An electromagnetic wave sensing device 72 is connected to a host 70. The sensing device 72 in this embodiment preferably includes a transmission interface 701 for communicating with the external circuit or device, such as to the host 70. The device 72 further has a control unit 702 which is used to process the signals signaling among the units therein. Furthermore, the control unit 702 is electrically connected with the transmission interface 701 for transferring the sensing signals to the host 70 after controlling the output range. The control unit 702 is particularly used to determine whether a certain interrupt condition is met in order to send the interrupt request to the host 70 and decide the timing to transfer the signals. The control unit 702 also controls the sensing modes mentioned above, such as the full working mode, sleep mode and semi-sleep mode.

A signal transforming unit 703 is electrically connected to the control unit 702. The signal transforming unit 703 is particularly used for performing a transformation, such as a photoelectric transformation used to transform light signal into electrical signal, or transform any signal into another state. After signal transformation, the signals are outputted according to the mentioned working mode configured. A function selector 704 is preferably included into this device in this embodiment. This function selector 704 is electrically connected with the signal transforming unit 703, and also the plurality of sensors, such as a temperature sensor 721, a first sensor 722, a second sensor 723, and more to an Nth sensor 724. By a switching mechanism, those sensors 722 to 724 can be functioned by manual switching through the function selector 704, in which one or more sensors will be initiated based on the selection. More, two or more sensors can also be initiated simultaneously to create broader sensing range.

In particular, the electromagnetic wave sensing device 72 supports an internal emitter 705 or/and also an external emitter 706. The internal emitter 705 can be disposed at one end of the device 72, and with those sensors 721, 722, 723, and 724. Furthermore, the internal emitter 705 is designed for being configured by the claimed electromagnetic wave sensing device 72. Users may directly set up the internal emitter 705 through the device 72 itself.

Moreover, the external emitter 706 is coupled to the device 72. Preferably, the emitter 706 is disposed outside the device 72, and being controlled through a remote host 70. The electromagnetic wave sensing device 72 can use those electromagnetic wave sensors 722 to 724 as the receives to sense one or more specific ranges of electromagnetic bands and generate one or more corresponding sensing signals, For example, the electromagnetic wave sensing device 72 utilizes the emitter 705 to emit a detection signal to detect a distance toward a remote object from a reflective signal which is sensed by one of the sensors. If the emitted light is an infrared, the reflected wave will be sensed by the one corresponding sensor, that is the emitted signal is reflected from the object and received by one of the sensors within a configured waveband. After that, a corresponding sensing signal is then generated.

Furthermore, the external emitter 706 is, for example, implemented to have a photo-interrupter which employs the emitter 706 and a receiver (the sensors). In this exemplary example, the photo-interrupter is, but not limited to, used to measure a distance from an object by the change of signals since the light between the emitter and the receiver is interrupted by the object the interaction.

The electromagnetic wave sensing device 72 particularly has the temperature sensor 721 in this embodiment. Since the change of ambient temperature may affect the accuracy of the measurement by the device 72, the temperature sensor 721 is disposed and used to measure the temperature around the device 72. The measured temperature becomes a basis for correcting the sensing signal. In the meantime, the value of measured temperature is transformed by the signal transforming unit 703 to electronic signal, which is especially to compensate the measurement by the device 72. Since the outputted signals from the device can be internally corrected by this compensation, the measurement can be more accurate.

More particularly, the present invention can set a plurality of interrupt points, which can be set through setting interface by external hosts. Additionally, it may further determine two types of interrupt modes, one is that interrupt occurs when the amplitude value exceeds a setting value, the other is that interrupt occurs when an accumulated value reaches a certain count.

In summary, the electromagnetic wave sensing device disclosed by the present invention is a sensing device which integrates two or more sensing units, signal transforming/control units and transmission interface, enabling the integration of calculation, transformation and parameter setting of sensing signals into one device, such that the product according to the present invention can generate consistent feature.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An electromagnetic wave sensing device, comprising:
a first sensing unit, including at least a first sensing component, which is used to sense ambient light and generates a first sensing signal;
a second sensing unit, including at least a second sensing component, which is used to sense electromagnetic wave of a specific range and generates a second sensing signal;
a means of sensing signal process, which is used to receive the signals sensed by the first sensing unit and the second sensing unit, to perform signal transformation, in order to set the working mode of the electromagnetic wave sensing device, and to output the result accordingly;
a temperature sensor, which is used to measure temperature around the electromagnetic wave sensing device, and the value of measured temperature is transformed to electronic signal referred for correcting the sensed signals;
an emitter, coupled to the electromagnetic wave sensing device, for emitting detection signals;
a transmission interface, by which the electromagnetic wave sensing device is connected to a host;
a control unit connected with the transmission interface, for transferring the sensing signals to the host; and
a function selector, electrically connected with the first sensing unit, the second sensing unit and the temperature sensor, wherein one or more of the first sensing unit, the second sensing unit and the temperature sensor are initiated based on a selection.

2. The electromagnetic wave sensing device according to claim 1, wherein the first sensing unit and second sensing unit include one or more diode components, and these diode components having a substrate with PN interfacing, metal layer, polymer layer, or combination thereof stacked thereon.

3. The electromagnetic wave sensing device according to claim 1, wherein the means of sensing signal process is, through a signal transforming unit, to transform the sensing signals into linear-to-linear or linear-to-log electrical signals.

4. The electromagnetic wave sensing device according to claim 3, wherein the means of sensing signal process is performed by a signal transforming unit electrically connected with the control unit, for performing a transformation.

5. The electromagnetic wave sensing device according to claim 1, wherein the emitter is an internal emitter which is configured via the electromagnetic wave sensing device.

6. The electromagnetic wave sensing device according to claim 1, wherein the emitter is an external emitter which is disposed outside the electromagnetic wave sensing device and being configured via the host.

7. The electromagnetic wave sensing device according to claim 1, wherein the first sensing unit and the second sensing unit respectively includes at least an electromagnetic wave filter for filtering the electromagnetic wave range to an electromagnetic wave range that human eyes can discern or to a specific electromagnetic wave range.

8. The electromagnetic wave sensing device according to claim 7, wherein the electromagnetic wave range discernible by human eyes is 450 nm to 650 nm, in which the maximum peak is located at about 550 nm.

9. The electromagnetic wave sensing device according to claim 1, wherein the means of sensing signal process, by parameters, controls the first sensing unit or the second sensing unit to stop operating and operating time thereof.

10. The electromagnetic wave sensing device according to claim 1, wherein the means of sensing signal process is used to determine the electromagnetic wave sensing range of the first sensing component and the second sensing component.

11. The electromagnetic wave sensing device according to claim 1, wherein the electromagnetic wave sensing device further includes a means of coupling, so as to couple to other application components.

12. The electromagnetic wave sensing device according to claim 1, wherein the working modes include a full working mode, a sleep mode, and a semi-sleep mode for periodically initiating the electromagnetic wave sensing device.

13. An electromagnetic wave sensing device, comprising:
two or more electromagnetic light sensors, wherein each of the sensors is to sense a specific range of electromagnetic band and generate a corresponding sensing signal;
a temperature sensor, which is used to measure temperature around the electromagnetic wave sensing device, and the measured temperature is a basis for correcting the sensing signal;
an emitter, coupled to the electromagnetic wave sensing device, for emitting detection signals;
a transmission interface, by which the electromagnetic wave sensing device is connected to a host;
a control unit connected with the transmission interface, for transferring the sensing signals to the host;
a signal transforming unit electrically connected with the control unit, for transforming the signals into another state; and
a function selector, electrically connected with the signal transforming unit, the electromagnetic light sensors and the temperature sensor, wherein one or more of the electromagnetic light sensor and the temperature sensor are initiated based on a selection.

14. The electromagnetic wave sensing device according to claim 13, wherein the signal transforming unit is used to perform a photoelectric transformation in order to transform the sensing signals to electronic signals.

15. The electromagnetic wave sensing device according to claim 13, wherein the emitter is an internal emitter which is configured via the electromagnetic wave sensing device.

16. The electromagnetic wave sensing device according to claim 13, wherein the emitter is an external emitter which is disposed outside the electromagnetic wave sensing device and being configured via the host.

17. The electromagnetic wave sensing device according to claim 13, wherein the electromagnetic light sensors, through the signal transforming unit, transform the sensing signals into linear-to-linear or linear-to-log electrical signals.

18. The electromagnetic wave sensing device according to claim 17, wherein the electrical signal includes voltage or current signal.

19. The electromagnetic wave sensing device according to claim 13, wherein the electromagnetic wave sensing device further includes a coupling circuit, so as to couple to other application components.

20. The electromagnetic wave sensing device according to claim 13, wherein the transformed signals are used to set one of a plurality of working modes including a full working mode, a sleep mode, and a semi-sleep mode for periodically initiating the electromagnetic wave sensing device.
